(19) United States
(12) Patent Application Publication
(10) Pub. No.: US 2026/0098636 A1
(43) Pub. Date: Apr. 9, 2026

(54) SURFACE MELTING FURNACE, METHOD FOR MONITORING SUPPLY STATE OF OBJECT BEING PROCESSED IN SURFACE MELTING FURNACE, AND METHOD FOR OPERATING SURFACE MELTING FURNACE

(71) Applicant: KUBOTA CORPORATION, Osaka (JP)

(72) Inventors: Yasumasa HIRATO, Hyogo (JP); Shigenori INOUE, Hyogo (JP); Fumiki HOSHO, Hyogo (JP)

(73) Assignee: KUBOTA CORPORATION, Osaka (JP)

(21) Appl. No.: 19/137,977

(22) PCT Filed: Dec. 5, 2023
(86) PCT No.: PCT/JP2023/043469

§ 371 Date: Jun. 11, 2025

(30) Foreign Application Priority Data
Dec. 14, 2022 (JP) 2022-199560

(51) Int. Cl. F23G 5/50; F23G 5/26

(52) U.S. Cl. CPC F23G 5/50; F23G 5/26; F23G 2207/101; F23G 2207/20

(57) ABSTRACT

Provided is a monitoring method of a supply state of a treatment object, the monitoring method being capable of accurately evaluating the supply state of the treatment object in a surface melting furnace. The monitoring method is a monitoring method for monitoring a supply state of a treatment object in a surface melting furnace including a melting chamber and configured to melt, from a top surface side, a treatment object bed resulting from the treatment object supplied into the melting chamber from a lateral side of the melting chamber. The monitoring method includes: capturing an image of an evaluation target area on a melt surface resulting from the treatment object bed being melted, and generating thermal image data indicating a temperature distribution in the evaluation target area; and evaluating a supply state of a treatment object based on the thermal image data.

### TECHNICAL FIELD

The present invention relates to a surface melting furnace for melting a treatment object bed from its top surface side, the treatment object bed resulting from a treatment object supplied into a melting chamber from a lateral side of the melting chamber, a monitoring method thereof, and an operation method thereof.

### BACKGROUND ART

As an example of the surface melting furnace, there has been known a surface melting furnace in which a treatment object in a storage chamber formed between an outer cylinder and an inner cylinder inward of the outer cylinder is supplied into a melting chamber formed below a ceiling provided on an inner periphery of the inner cylinder and is melted by heat generated by a burner provided for the ceiling so as to be turned into molten slag, and the molten slag flows down by gravity to outside from the melting chamber through a slag port on a floor of the outer cylinder (see Patent Literature 1).

The surface melting furnace has such a problem that energy cost for the burner accounts for most of the running cost of the whole melting furnace. In order to deal with this problem, a combustion improver (waste plastic and the like) containing carbon and hydrogen is mixed with the treatment object, so that part of heat necessary to melt the treatment object is covered by heat generated in response to the combustion improver being burnt in the melting chamber.

In the meantime, in a case of a surface melting furnace in which a treatment object is supplied to a melting chamber from its lateral side, the treatment object newly supplied to the melting chamber may be supplied under a melting surface resulting from the treatment object bed being melted in the melting chamber (that is, the treatment object thus newly supplied gets under the melting surface) depending on the height of the melting surface. Such a supply state of the treatment object is generally considered as a bad state and should be avoided. The reason is because oxygen is not sufficiently supplied to the combustion improver mixed in the treatment object, and unburned loss is caused due to imperfect combustion, thereby decreasing a furnace temperature and a throughput in the surface melting furnace.

### CITATION LIST

### Patent Literature

Patent Literature 1: Japanese Unexamined Patent Application Publication No. 09-264523

### SUMMARY OF INVENTION

### Technical Problem

It has been known that the imperfect combustion of the combustion improver causes carbon monoxide, and dioxin, which is a toxic substance, is generated in a case where waste plastic containing vinyl chloride is used as the combustion improver. In view of this, in the related art, such a method is used that imperfect combustion is detected based on components of discharge gas from the melting chamber, and the supply state of the treatment object is evaluated as bad in response to the imperfect combustion being detected, and in that case, an operation condition of the surface melting furnace is adjusted so that the treatment object is supplied above the melting surface.

However, it takes a given period of time after the imperfect combustion of the combustion improver occurs or is eliminated until the components of the discharge gas change, and therefore, the components of the discharge gas do not necessarily reflect a current supply state of the treatment object. That is, the method in the related art has such a problem that the supply state of the treatment object cannot be grasped in real time, and as a result, it is difficult to timely adjust the operation condition and to effectively avoid the occurrence of imperfect combustion and a decrease in the furnace temperature and the throughput due to the occurrence of imperfect combustion.

The present invention is accomplished in view of the above circumstances, and one object of the present invention is to provide a monitoring method of a supply state of a treatment object which monitoring method can accurately evaluate the supply state of the treatment object in a surface melting furnace by grasping the supply state in real time. Another object of the present invention is to provide an operation method of a surface melting furnace which operation method can timely adjust an operation condition based on an evaluation result on a supply state of a treatment object. Further another object of the present invention is to provide a surface melting furnace to which the monitoring method and the operation method can be applied.

### Solution to Problem

In order to achieve the above object, a monitoring method according to the present invention is a monitoring method for monitoring a supply state of a treatment object in a surface melting furnace including a melting chamber and configured to melt, from an upper surface side, a treatment object bed resulting from the treatment object supplied into the melting chamber from a lateral side of the melting chamber. The monitoring method includes: an imaging step of capturing an image of an evaluation target area on a melting surface resulting from the treatment object bed being melted, and generating thermal image data indicating a temperature distribution in the evaluation target area; and an evaluation step of evaluating a supply state of a treatment object newly supplied into the melting chamber, based on the thermal image data.

The treatment object newly supplied into the melting chamber has a temperature lower than that of the melting surface. In a case where the treatment object thus newly supplied covers the melting surface, the thermal image data acquired by capturing an image of the melting surface contains a low temperature region indicating the treatment object at the low temperature. In the meantime, in a case where the treatment object thus newly supplied is under the melting surface, the treatment object at the low temperature is covered with the melting surface at a high temperature, so that the thermal image data does not contain the low temperature region. That is, the thermal image data directly reflects the position of the treatment object newly supplied, relative to the melting surface. Accordingly, with the monitoring method configured as described above, it is possible to accurately evaluate the supply state of the treatment object by grasping the supply state of the treatment object in real time based on the thermal image data.

In order to achieve the above object, an operation method according to the present invention is an operation method of a surface melting furnace including a melting chamber and configured to melt, from an upper surface side, a treatment object bed resulting from a treatment object supplied into the melting chamber from a lateral side of the melting chamber. The operation method includes: a supply step of supplying a treatment object into the melting chamber; a heating step of heating the melting chamber in such a manner as to melt the treatment object bed; an imaging step of capturing an image of an evaluation target area on a melting surface resulting from the treatment object bed being melted, and generating thermal image data indicating a temperature distribution in the evaluation target area; an evaluation step of evaluating a supply state of a treatment object newly supplied into the melting chamber, based on the thermal image data; and an adjusting step of adjusting an operation condition of the surface melting furnace in response to the supply state of the treatment object being evaluated as bad.

In the operation method configured as described above, it is possible to accurately evaluate the supply state of the treatment object newly supplied into the melting chamber, as described above. Hereby, it is possible to timely adjust an operation condition of the surface melting furnace based on a result of the evaluation. For example, in response to the supply state of the treatment object is evaluated as bad (that is, the treatment object is under the melting surface), the operation condition of the surface melting furnace is adjusted such that the treatment object to be newly supplied subsequently is supplied into the melting chamber in a good state (that is, in such a manner that the treatment object covers the melting surface). Hereby, oxygen is easily supplied to a combustion improver mixed in the treatment object, thereby making it possible to more surely avoid imperfect combustion of the combustion improver and a decrease in a furnace temperature and a throughput of the surface melting furnace due to the imperfect combustion.

In the monitoring method or the operation method according to the above configuration, the evaluating may include evaluating the supply state of the treatment object as bad in response to an area of a low temperature region at a temperature lower than a predetermined temperature in the thermal image data is below a predetermined threshold, or in response to a proportion of the area of the low temperature region to an area of a predetermined range in the thermal image data is below a predetermined threshold.

In the above configuration, in response to the area of the low temperature region or the proportion of the area of the low temperature region to the area of the predetermined range in the thermal image data is below the predetermined threshold, it is possible to evaluate the supply state of the treatment object as bad.

In the operation method according to the above configuration, the adjusting may include at least one of decelerating of a supply speed of the treatment object to be supplied to the melting chamber, raising of a supply position at which the treatment object is supplied to the melting chamber, or increasing of a temperature of the melting chamber.

In either of a case where the supply speed of the treatment object to be supplied to the melting chamber is decelerated and a case where the temperature of the melting chamber is raised, the amount (i.e., the throughput) of slag formed by the treatment object bed being melted is larger than the supply amount of the treatment object newly supplied into the melting chamber. Accordingly, the treatment object bed in the melting chamber is reduced eventually, and the melting surface recedes downward and outward in the melting chamber along with that. As a result, the treatment object newly supplied into the melting chamber easily covers the melting surface. Even in a case where the supply position at which the treatment object is supplied into the melting chamber is raised, the treatment object newly supplied into the melting chamber also easily covers the melting surface. Accordingly, with the operation method configured as described above, it is possible to adjust the operation condition of the surface melting furnace by adjusting at least one of the supply speed of the treatment object, the supply position of the treatment object, and the temperature of the melting chamber.

In the monitoring method or the operation method according to the above configuration, the area of the low temperature region or the proportion of the area of the low temperature region to the area of the predetermined range in the thermal image data may be a moving average in a predetermined period of time.

The position of the treatment object newly supplied into the melting surface changes over time and also changes depending on a part of the melt surface. In the operation method configured as described above, these changes are averaged, and the supply state of the treatment object can be evaluated based on that. As a result, it is possible to prevent an influence of a temporary or local abnormality in the position of the treatment object newly supplied relative to the melt surface from affecting the result of the evaluation.

In the monitoring method or the operation method according to the above configuration, the surface melting furnace may be a rotary surface melting furnace including: a ceiling provided with a heating device and above the melting chamber; an inner cylinder around the ceiling, extending upward, and configured to be lifted and lowered together with the ceiling; a bottomed outer cylinder disposed outward of the inner cylinder and rotatable relative to the inner cylinder; and a guide device provided for a lower end portion of the inner cylinder and configured to guide a treatment object from a storage chamber into the melting chamber as the outer cylinder rotates, the storage chamber being defined by an outer peripheral surface of the inner cylinder and an inner peripheral surface of the outer cylinder.

Even in the rotary surface melting furnace configured as described above, it is possible to suitably perform the monitoring method or the operation method according to the above configuration.

In order to achieve the above object, a surface melting furnace according to the present invention is a surface melting furnace including: a melting chamber configured to melt, from an upper surface side, a treatment object bed resulting from a treatment object supplied into the melting chamber from a lateral side of the melting chamber; an imaging device configured to capture an image of an evaluation target area on a melt surface resulting from the treatment object bed being melted, and generate thermal image data indicating a temperature distribution in the evaluation target area; and a control device configured to evaluate a supply state of a treatment object newly supplied into the melting chamber, based on the thermal image data, and adjust an operation condition of the surface melting furnace in response to evaluating the supply state of the treatment object as bad.

In a case where the operation method according to the above configuration is applied to the surface melting furnace configured as described above, the control device can perform the evaluation step and the adjusting step. That is, with the surface melting furnace configured as described above, it is possible to automatically evaluate the supply state of the treatment object and adjust the operation condition of the surface melting furnace based on a result of the evaluation.

### BRIEF DESCRIPTION OF DRAWINGS

FIG. 1 is a longitudinal sectional view illustrating a schematic configuration of a surface melting furnace according to the present invention;

FIG. 2 is a block diagram illustrating a schematic configuration of the surface melting furnace according to the present invention;

FIG. 3 is a schematic view illustrating an imaging range of an infrared camera in the surface melting furnace; and

FIG. 4 is a schematic view illustrating a thermal image captured by the infrared camera.

### DESCRIPTION OF EMBODIMENTS

The following describes embodiments of a surface melting furnace, a monitoring method thereof, and an operation method thereof. Note that the following description describes a rotary surface melting furnace for incineration ash generated in a waste incinerator or the like as a treatment target. However, the present invention is not limited to this, and the present invention can be applied to any surface melting furnace.

### First Embodiment

### Structure of Surface Melting Furnace

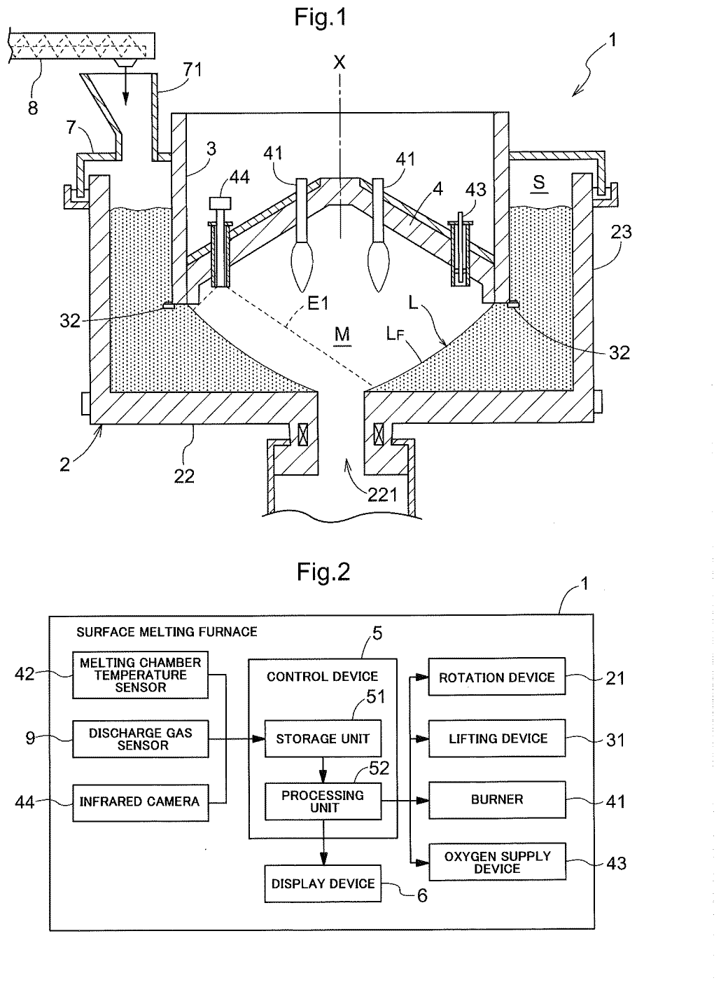

As illustrated in FIGS. 1, 2, a surface melting furnace 1 includes a bottomed outer cylinder 2, an inner cylinder 3 placed inward of the outer cylinder 2 in such a manner that the inner cylinder 3 is coaxial with the outer cylinder 2 at an axis X, a ceiling 4 provided for a lower portion of an inner peripheral surface of the inner cylinder 3, a control device 5 configured to control the operation of the surface melting furnace 1, and a display device 6.

The outer cylinder 2 is configured to rotate relative to the inner cylinder 3. The outer cylinder 2 is coupled with a rotation device 21 (having a well-known configuration and therefore not illustrated in FIG. 1 and not described in detail), and the rotation device 21 rotates the outer cylinder 2 relative to the inner cylinder 3. A storage chamber S in an annular shape is defined by an inner peripheral surface of the outer cylinder 2 and an outer peripheral surface of the inner cylinder 3, and a cover 7 covering an upper opening of the storage chamber S is held by an upper portion of the inner cylinder 3. The cover 7 includes a hopper 71, and the incineration ash mixed with waste plastic as a combustion improver is fed as a treatment object from a conveyor 8 to the storage chamber S through the hopper 71 and is stored in the storage chamber S. Note that the combustion improver is not limited to waste plastic, and any combustion improver is usable, provided that the combustion improver is inflammable.

The inner cylinder 3 is provided upright on the outer periphery of the ceiling 4 and is liftable and lowerable together with the ceiling 4. The inner cylinder 3 is coupled with a lifting device 31 (having a well-known configuration and therefore not illustrated in FIG. 1 and not described in detail), and the lifting device 31 lifts and lowers the inner cylinder 3 and the ceiling 4 relative to the outer cylinder 2. A plurality of guide blades 32 (an example of a guide device) is provided for a lower end portion of the inner cylinder 3 at intervals in a circumferential direction of the inner cylinder 3. The plurality of guide blades 32 is configured to guide a treatment object from the storage chamber S outside the inner cylinder 3 into the inner cylinder 3 as the outer cylinder 2 rotates.

The ceiling 4 has a generally conical shape open downward, and a melting chamber M is formed between the ceiling 4 and a floor 22 of the outer cylinder 2. A treatment object bed L having a generally mortar shape in a sectional view is formed in the melting chamber M in response to the treatment object being guided and supplied therein. The ceiling 4 is provided with a burner 41 (an example of a heating device), and the burner 41 heats the melting chamber M to a temperature of 1200° C. to 1400° C., which is equal to or more than a Flow Temperature of the incineration ash. The temperature in the melting chamber M is measured by a melting chamber temperature sensor 42 constituted by a thermoelectric couple provided for the ceiling 4, for example, and is transmitted to the control device 5 as a signal.

The burner 41 heats the melting chamber M, so that the treatment object bed L is melted from its top surface side. Slag as a molten material flows down by gravity and is discharged together with discharge gas in the melting chamber M from a cinder outlet (a slag port) 221 placed in generally the center of the floor 22 of the outer cylinder 2. The surface of the treatment object bed L recedes due to melting but is maintained generally at a constant position and in a constant shape because the treatment object is newly guided and supplied into the melting chamber M by the outer cylinder 2 rotating continuously or regularly. The components of the discharge gas discharged from the cinder outlet 221 are measured by a discharge gas sensor 9 and transmitted to the control device 5 as a signal.

The ceiling 4 is also provided with an oxygen supply device 43 configured to supply oxygen or gas containing oxygen to a combustion improver on the surface of a corner portion of the treatment object bed L which corner portion is adjacent to the inner cylinder 3, in such a manner as to promote combustion. The oxygen supply device 43 is provided on an outer peripheral side of the ceiling 4.

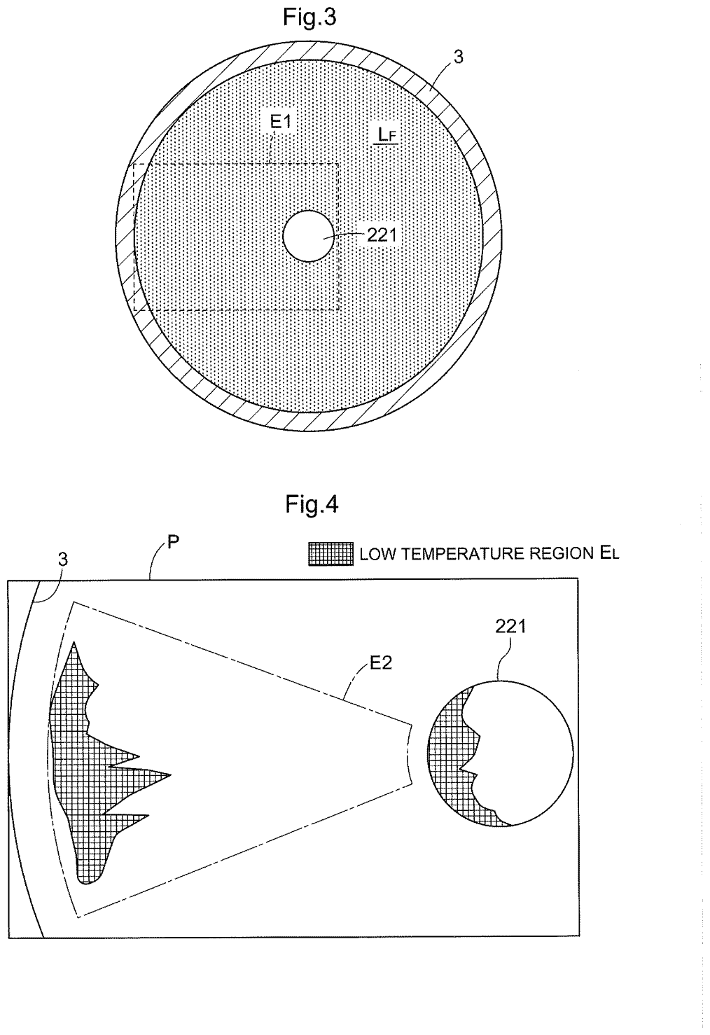

The ceiling 4 is further provided with an infrared camera 44 (an example of an imaging device) configured to capture an image of a melt surface LF resulting from the treatment object bed L being melted and to generate thermal image data indicating a temperature distribution of the melt surface LF by color or lightness. As illustrated in FIG. 3, the treatment object bed L has a generally ring shape in a plan view, and the infrared camera 44 captures at least part of the surface of the treatment object bed L in its circumferential direction as an imageable range E1. Note that, in the present embodiment, the imageable range E1 also covers the whole cinder outlet 221. The thermal image data generated by the infrared camera 44 is transmitted to the control device 5 as a signal.

The control device 5 includes a storage unit 51 including a memory, for example, and a processing unit 52 including a processor, for example. The storage unit 51 receives and stores signals from the infrared camera 44, the melting chamber temperature sensor 42, and the discharge gas sensor 9 and transmits the signals thus stored to the processing unit 52 in response to a request from the processing unit 52.

The processing unit 52 performs image-processing on the thermal image data generated by the infrared camera 44 as needed and transmits it to the display device 6, so that the thermal image data is displayed on the display device 6.

The processing unit 52 adjusts an operation condition of the surface melting furnace 1 based on the signals from the melting chamber temperature sensor 42 and the discharge gas sensor 9. More specifically, in response to the temperature of the melting chamber M which temperature is measured by the melting chamber temperature sensor 42 becomes lower than the Flow Temperature of the incineration ash, the processing unit 52 increases respective amounts of fuel and oxygen to be supplied to the burner 41. Additionally, the oxygen supply device 43 may increase the amount of oxygen to be supplied into the melting chamber M. This increases output of the burner 41, thereby increasing the temperature of the melting chamber M.

In a case where the amount of toxic substances such as carbon monoxide that is measured by the discharge gas sensor 9 becomes equal to or more than a restriction value, the processing unit 52 increases the output of the burner 41 so as to increase the temperature of the melting chamber M, decreases the output of the rotation device 21 so as to decrease the supply speed of the treatment object to be supplied to the melting chamber M, or performs both in combination. In response to the treatment object being heated to a higher temperature or being heating to a high temperature for a long period of time, the generation of toxic substances such as carbon monoxide is restrained.

The display device 6 is configured to display the thermal image data or the like generated by the infrared camera 44 for an operator of the surface melting furnace 1 and includes a panel display, for example.

### Monitoring Method

The following describes a monitoring method of the supply state of the treatment object in the surface melting furnace 1 configured as described above. In the first embodiment, the monitoring method includes an imaging step S13 and an evaluation step S14.

In the imaging step S13, the infrared camera 44 captures an area of the melt surface LF resulting from the treatment object bed L being melted which area corresponds to an imageable range E1 and generates thermal image data. A thermal image P (FIG. 4) indicated by the thermal image data is displayed on the display device 6 for the operator.

During the operation of the surface melting furnace 1, the treatment object bed L is melted from its top surface side by the melting chamber M being heated, and the treatment object is newly supplied to the melting chamber M by rotation of the outer cylinder 2, as described above. In a case where the treatment object is newly supplied to cover the melt surface LF in the imageable range E1, the thermal image P contains a low temperature region EL indicating the treatment object thus newly supplied and at a low temperature. In the meantime, in a case where the treatment object is newly supplied under the melt surface LF, the treatment object thus newly supplied and at a low temperature is covered with the melt surface LF at a high temperature, so that the thermal image P does not contain such a low temperature region EL. That is, the supply state of the treatment object can be grasped based on the low temperature region EL to appear on the thermal image P.

Note that, although not illustrated in the thermal image P in FIG. 4 for simplification of the drawing, the low temperature region EL in an actual thermal image may contain a plurality of areas classified by color or lightness based on temperature differences, and this also applies to regions (i.e., a high temperature region) other than the low temperature region EL.

In the evaluation step S14, the operator evaluates the supply state of the treatment object based on the thermal image P. More specifically, whether or not the area of the low temperature region EL in an evaluation target area E2, which is a predetermined range in the thermal image P or the proportion of the area of the low temperature region EL to the area of the evaluation target area E2 is below a predetermined reference is evaluated.

The evaluation target area E2 is an area surrounded by a virtual boundary determined artificially. In the present embodiment, the evaluation target area E2 is a generally sector-shaped area reduced in width in the circumferential direction from an area adjacent to the inner cylinder 3 toward an area adjacent to the cinder outlet 221 on the thermal image P. However, the present invention is not limited to this, and the evaluation target area E2 may be areas in other shapes or the evaluation target area E2 may be the whole thermal image P.

The low temperature region EL is a region at a temperature lower than a predetermined temperature. The predetermined temperature can be determined appropriately based on the type of the treatment object, the operation condition of the surface melting furnace, or the like. In the present embodiment, the low temperature region EL can be a region at a temperature lower than 1250° C., for example. As another example, the predetermined temperature can be a value obtained by multiplying a maximum temperature Tmax on the thermal image P by a coefficient (for example, 0.9) smaller than 1. In this case, the area or the proportion of the low temperature region EL changes in accordance with the maximum temperature Tmax, and therefore, it is possible to evaluate the supply state with accuracy.

The predetermined reference may be determined subjectively by the operator or may be a predetermined threshold determined objectively. In the latter case, the operator performs evaluation by finding the area or the proportion by calculation. The threshold of the proportion of the area of the low temperature region EL to the area of the evaluation target area E2 can be 5%, for example. The threshold of the area of the low temperature region EL can be a value calculated from the area of the evaluation target area E2 in consideration of the threshold of the proportion.

In a case where the operator determines that the area of the low temperature region EL or the proportion of the area of the low temperature region EL to the area of the evaluation target area E2 is below the predetermined reference, the operator evaluates the supply state of the treatment object as bad. Thus, the supply state of the treatment object can be monitored.

Note that, in order to facilitate the monitoring of the supply state by the operator, at least one of the boundary of the evaluation target area E2, a value indicating the area of the evaluation target area E2, the boundary of the low temperature region EL, a value indicating the area of the low temperature region EL, and a value indicating the proportion of the area of the low temperature region EL to the area of the evaluation target area E2 may be inserted in the thermal image P displayed on the display device 6, by image processing performed by the processing unit 52 of the control device 5.

### Operation Method

The following describes an operation method of the surface melting furnace 1. In the first embodiment, the operation method includes a supply step S11, a heating step S12, the imaging step S13, the evaluation step S14, and an adjusting step S15.

The supply step S11 is a step of guiding the treatment object stored in the storage chamber S and supplying the treatment object into the melting chamber M by the outer cylinder 2 being rotated by the operation of the rotation device 21 in such a manner as to form the treatment object bed L and refill the storage chamber S with the treatment object just by a melted amount of the treatment object.

The heating step S12 is a step of heating the melting chamber M by operating the burner 41 or by operating the burner 41 and the oxygen supply device 43 in such a manner as to melt the treatment object bed L from a top surface side of the treatment object bed L. During the operation of the surface melting furnace 1, the melting chamber Mis continuously heated in the heating step S12, and the treatment object is continuously or intermittently supplied in the supply step S11 at the same time as the heating step S12, so that a process of melting the treatment object is continuously performed. In the heating step S12, heat necessary to melt the treatment object is partially covered by heat generated in response to the combustion improver being burnt in the melting chamber.

The imaging step S13, the evaluation step S14, and the adjusting step S15 are performed continuously or at every predetermined time during the operation of the surface melting furnace 1. The imaging step S13 and the evaluation step S14 are performed in the same manner as described in the monitoring method and therefore not described herein.

The adjusting step S15 is a step of the operator adjusting the operation condition of the surface melting furnace 1 in response to the supply state of the treatment object is evaluated as bad in the evaluation step S14. More specifically, the operator decelerates the rotation speed of the outer cylinder 2 by decreasing the output of the rotation device 21 so as to decelerate the supply speed of the treatment object to be supplied to the melting chamber M or increases the temperature of the melting chamber M by increasing the output of the burner 41. In this case, the amount (i.e., a throughput) of slag discharged from the melting chamber M exceeds the supply amount of the treatment object supplied to the melting chamber M, so that the melt surface LF recedes toward the floor 22 of the outer cylinder 2 and a peripheral wall portion 23. As a result, the treatment object newly supplied to the melting chamber M easily covers the melt surface LF. Alternatively, the operator lifts the inner cylinder 3 via the lifting device 31 to raise a supply position at which the treatment object is supplied to the melting chamber M. In this case, the treatment object newly supplied to the melting chamber M also easily covers the melt surface LF. Alternatively, the operator may perform two or more of these adjustment operations in combination.

The imaging step S13, the evaluation step S14, and the adjusting step S15 are repeatedly performed until the area of the low temperature region EL in the evaluation target area E2 on the thermal image P or the proportion of the area of the low temperature region EL to the area of the evaluation target area E2 reaches the predetermined reference or more.

### Second Embodiment

The present embodiment is different from the first embodiment in that the control device 5 is configured to perform the evaluation step S14 in the monitoring method and the operation method and the adjusting step S15 in the operation method. In the following description, descriptions of the same configuration as in the first embodiment are omitted.

In the evaluation step S14, the processing unit 52 evaluates the supply state of the treatment object based on thermal image data received from the storage unit 51. More specifically, the processing unit 52 specifies, by image processing, the evaluation target area E2 and the low temperature region EL on the thermal image P indicated by the thermal image data and calculates the area of the low temperature region EL or the proportion of the area of the low temperature region EL to the area of the evaluation target area E2. The processing unit 52 determines whether or not the value thus calculated is below a predetermined threshold, and in a case where the processing unit 52 determines that the value thus calculated is below the predetermined threshold, the processing unit 52 evaluates the supply state of the treatment object as bad.

In the adjusting step S15, the processing unit 52 adjusts the operation condition of the surface melting furnace 1 in response to the supply state of the treatment object is evaluated as bad. A method for adjusting the operation condition is the same as the method described in the first embodiment.

Note that the determination in the evaluation step S14 may be performed based on a moving average in a predetermined period of time. That is, the processing unit 52 calculates the area of the low temperature region EL and the proportion of the area of the low temperature region EL to the area of the evaluation target area E2 for each of a plurality of thermal images P received from the storage unit 51 for the predetermined period of time and finds a moving average in the predetermined period of time based on the area or the proportion thus acquired. Thus, the processing unit 52 can use the moving average for the determination.

The processing unit 52 may transmit a result of the evaluation in the evaluation step S 14 to an output device (the display device 6 or devices in other given forms that can transmit information to the operator).

### Other Embodiments

A plurality of infrared cameras 44 configured to generate thermal image data on the melt surface LF may be provided at intervals in the circumferential direction of the ceiling 4. In the rotary surface melting furnace, the rotation speed of the outer cylinder 2 relative to the inner cylinder 3 may be set small (for example, one rotation per one to two hours). In such a case, an interval between a previous monitoring and a subsequent monitoring on the same part of the melt surface LF in the circumferential direction may become long. However, the above configuration enables monitoring on the same part at a shorter interval.

In a case where the plurality of infrared cameras 44 configured to generate thermal image data is provided, it is possible to estimate the shape of the melt surface LF (for example, the melt surface LF swells or is thin) based on pieces of thermal image data from the infrared cameras 44 having different parallactic angles. In view of this, the operation method of the surface melting furnace according to the present invention may further include a step of adjusting the melt surface LF into an appropriate shape by adjusting at least one of the supply speed of the treatment object, the temperature of the melting chamber, and other operation conditions, based on a result of the estimation on the shape of the melt surface LF. Note that it is preferable that the shape of the melt surface LF be estimated with the use of thermal image data in which the melt surface LF appears without being disturbed by flame. However, instead of this, visible light image data captured by a visible light camera can also be used.

In a case where the guide blades 32 configured to guide the treatment object in the storage chamber S and supply it to the melting chamber M along with rotation of the outer cylinder 2 has an abnormality (for example, breakage of the guide blades 32 or clogging of the guide blades 32 with the treatment object), the abnormality also affects the supply state of the treatment object to be newly supplied to the melting chamber M. In view of this, the operation method according to the present invention may further include an abnormality determination step of determining whether or not the guide blades 32 have an abnormality, based on thermal image data. In the abnormality determination step, for example, a value (an area ratio, an increase of the area, or the like) indicating a change of the area of the low temperature region EL which region is indicated by thermal image data after a predetermined time elapses from the execution of the adjusting step S15, relative to the area of the low temperature region EL which region is indicated by thermal image data before the adjusting step S15 is performed, is found, and when the value thus found becomes lower than a predetermined threshold, it can be determined that the guide blades 32 have an abnormality.

In response to decreasing of the temperature of slag flowing down by gravity through the cinder outlet 221, a hanging object (the low temperature region EL in the cinder outlet 221 on the thermal image P in FIG. 4) in an icicle shape may be formed in the cinder outlet 221. The surface melting furnace 1 according to the present invention may further include a striking device configured to determine a formation state of such a hanging object and strike the hanging object such that the hanging object drops from the cinder outlet 221. Since the hanging object appears as the low temperature region EL on the thermal image P, the operation method according to the present invention may further include a removal step of determining the position of the hanging object in the cinder outlet 221 based on the thermal image P and removing the hanging object by operating the striking device at the timing when the position of the hanging object comes to a position at which the hanging object can be struck by the striking device.

The above embodiment has described that the area of the low temperature region EL is calculated based on the thermal image P indicated by the thermal image data, but the present invention is not limited to this. For example, the number of pixels (the number of data) corresponding to the low temperature region EL may be calculated based on temperature information included in data of pixels constituting the thermal image P, and the area of the low temperature region EL may be calculated based on the number of pixels (the number of data). In the present invention, the thermal image P and a set of data of pixels constituting the thermal image P are collectively referred to as thermal image data.

### Description of Reference Numerals

1: surface melting furnace
2: outer cylinder
21: rotation device
22: floor
221: cinder outlet (slag port)
23: peripheral wall portion
3: inner cylinder
31: lifting device
32: guide blade (guide device)
4: ceiling
41: burner (heating device)
42: melting chamber temperature sensor
43: oxygen supply device
44: infrared camera (imaging device)
5: control device
51: storage unit
52: processing unit
6: display device
7: cover
71: hopper
8: conveyor
9: discharge gas sensor
S: storage chamber
M: melting chamber
L: treatment object bed
LF: melting surface
P: thermal image
E1: imageable range
E2: evaluation target area
EL: low temperature region
X: axis

1. A monitoring method for monitoring a supply state of a treatment object in a surface melting furnace including a melting chamber and configured to melt, from an upper surface side, a treatment object bed resulting from the treatment object supplied into the melting chamber from a lateral side of the melting chamber, the monitoring method comprising:
capturing an image of an evaluation target area on a melt surface resulting from the treatment object bed being melted, and generating thermal image data indicating a temperature distribution in the evaluation target area; and
evaluating a supply state of a treatment object newly supplied into the melting chamber, based on the thermal image data.

2. An operation method of a surface melting furnace including a melting chamber and configured to melt, from an upper surface side, a treatment object bed resulting from a treatment object supplied into the melting chamber from a lateral side of the melting chamber, the operation method comprising:
supplying a treatment object into the melting chamber;
heating the melting chamber in such a manner as to melt the treatment object bed;
capturing an image of an evaluation target area on a melt surface resulting from the treatment object bed being melted, and generating thermal image data indicating a temperature distribution in the evaluation target area;
evaluating a supply state of a treatment object newly supplied into the melting chamber, based on the thermal image data; and
adjusting an operation condition of the surface melting furnace in response to the supply state of the treatment object is evaluated as bad.

3. The operation method according to claim 2, wherein
the evaluating includes evaluating the supply state of the treatment object as bad in response to an area of a low temperature region in the thermal image data at a temperature lower than a predetermined temperature is below a predetermined threshold, or in response to a proportion of the area of the low temperature region to an area of a predetermined range in the thermal image data is below a predetermined threshold.

4. The operation method according to claim 2, wherein
the adjusting includes at least one of decelerating of a supply speed of the treatment object to be supplied to the melting chamber, raising of a supply position at which the treatment object is supplied to the melting chamber, or increasing of a temperature of the melting chamber.

5. The operation method according to claim 3, wherein
the area of the low temperature region or the proportion of the area of the low temperature region to the area of the predetermined range in the thermal image data is a moving average in a predetermined period of time.

6. The operation method according to claim 2, wherein
the surface melting furnace is a rotary surface melting furnace including:
a ceiling provided with a heating device and above the melting chamber;
an inner cylinder around the ceiling, extending upward, and configured to be lifted and lowered together with the ceiling;
a bottomed outer cylinder disposed outward of the inner cylinder and rotatable relative to the inner cylinder; and
a guide device provided for a lower end portion of the inner cylinder and configured to guide a treatment object from a storage chamber into the melting chamber as the outer cylinder rotates, the storage chamber being defined by an outer peripheral surface of the inner cylinder and an inner peripheral surface of the outer cylinder.

7. A surface melting furnace, comprising:
a melting chamber configured to melt, from an upper surface side, a treatment object bed resulting from a treatment object supplied into the melting chamber from a lateral side of the melting chamber;
an imaging device configured to capture an image of an evaluation target area on a melt surface resulting from the treatment object bed being melted, and generate thermal image data indicating a temperature distribution in the evaluation target area; and
a control device configured to evaluate a supply state of a treatment object newly supplied into the melting chamber, based on the thermal image data, and adjust an operation condition of the surface melting furnace in response to evaluating the supply state of the treatment object as bad.

8. The operation method according to claim 3, wherein
the adjusting includes at least one of decelerating of a supply speed of the treatment object to be supplied to the melting chamber, raising of a supply position at which the treatment object is supplied to the melting chamber, or increasing of a temperature of the melting chamber.

9. The operation method according to claim 3, wherein
the surface melting furnace is a rotary surface melting furnace including:
a ceiling provided with a heating device and above the melting chamber;
an inner cylinder around the ceiling, extending upward, and configured to be lifted and lowered together with the ceiling;
a bottomed outer cylinder disposed outward of the inner cylinder and rotatable relative to the inner cylinder; and
a guide device provided for a lower end portion of the inner cylinder and configured to guide a treatment object from a storage chamber into the melting chamber as the outer cylinder rotates, the storage chamber being defined by an outer peripheral surface of the inner cylinder and an inner peripheral surface of the outer cylinder.
